(19) United States
(12) Patent Application Publication
(10) Pub. No.: US 2009/0244755 A1
(43) Pub. Date: Oct. 1, 2009

(54) METHOD FOR MEASURING WRITE WIDTH AND/OR READ WIDTH OF A COMPOSITE MAGNETIC HEAD AND A MEASURING DEVICE USING THE METHOD

(76) Inventors: Hideki MOCHIZUKI, Ashigarakami-gun (JP); Yoshihiro Sakurai, Ashigarakami-gun (JP); Toshiaki Suzuki, Ashigarakami-gun (JP); Yokio Yamamoto, Kokubunji-shi (JP)

Correspondence Address: MATTINGLY & MALUR, P.C., 1800 DIAGONAL ROAD, SUITE 370, ALEXANDRIA, VA, 22314, US

(21) Appl. No.: 12/370,254

(22) Filed: Feb. 12, 2009

(30) Foreign Application Priority Data
Mar. 31, 2008 (JP) 2008-089468

(51) Int. Cl. G11B 27/36

(52) U.S. Cl. 360/31; G9B/27.052

(57) ABSTRACT

A method for measuring a write width and/or a read width of a composite magnetic head in which a read characteristics profile having a peak as a read voltage characteristics for a moving distance is obtained by writing a test data in a designated track of eccentric tracks of such as a DTM by the composite magnetic head (write head), reading the test data from the designated track by moving the composite magnetic head (read head) in a radial direction and crossing the designated track and a write sensitive width or a read sensitive width is calculated on the basis of the read characteristics profile.

### TECHNICAL FIELD

This invention relates to a measuring method for measuring write width and/or read width of a composite magnetic head and a measuring device for performing the measuring method. Particularly, in a characteristics test of a composite magnetic head including an MR (magneto-resistance) read head and a thin film inductive write head, the invention relates to a measuring method for easily measuring a write sensitive width of the write head and/or a read sensitive width of the MR head (read head) of the composite magnetic head by reading and writing data with respect to a magnetic recording medium (discrete track media (DTM)) of a discrete track system, a track width of which is narrower than the write sensitive width of the thin inductive head (write head) and a measuring device for performing the method.

### BACKGROUND ART

The hard disk drive (HDD) for a disk of 3.5 to 1.8 inches or even 1.0 inch or less has been used in various fields of automobile products, home electrical appliances and audio appliances, etc. Therefore, the reduction of cost of hard disk drive and the mass production thereof have been requested and the large memory capacity thereof has been also requested.

In order to satisfy these requests, there is a tendency that the high density recording magnetic disk media of the vertical magnetic memory system, which has lately been put to practical use, has been employed in the above mentioned fields and spread rapidly.

The magnetic disk medium of the vertical magnetic memory system is used in a composite magnetic head having a TMR (tunnel magneto-resistance) head or a GMR (giant magneto-resistance) head, which is a memory medium separable from the head by 10 nanometer or less controllably.

Such magnetic disk medium generally includes a glass substrate, a soft magnetic layer formed on the glass substrate and a magnetic layer provided on the soft magnetic layer. Discrete tracks are formed in a discrete substrate by etching the magnetic layer. (Incidentally, the term “disk substrate” is used as a material of a magnetic disk to be mounted on a hard disk drive.)

The etching for forming grooves between tracks is performed through an uneven photo-resist film. The unevenness of the photo-resist film is formed by forming the photo-resist film on the magnetic layer of the disk substrate by using the nano-print lithography and pushing the photo-resist film with an uneven stamper. The track width of the discrete track formed by the dry etching through the uneven photo-resist film is 100 nm or less and the groove separating adjacent tracks is filled with a non-magnetic material in a later step.

Such technique is described in JP-2007-012119A and JP-2007-149155A, etc., and is well known.

The magnetic disk of this kind is called as a magnetic recording medium of the discrete track system (DTM) and is currently paid attention to a technique capable of realizing ultra high density recording exceeding 1 terabit/(inch)² for 2.5 inches several years later. Further, the bit patterned medium (BPM) having discrete tracks, which are finely separated magnetically in the track direction, has been entered into the practical implementation step recently.

Since a magnetic film of the prior art magnetic disk used in HDD is formed on the whole surface of the medium, the prior magnetic disk is easily possible to record test data (test burst signal) in arbitrary track by a write head. Therefore, the read voltage characteristics, that is, the read characteristics profile (waveform), with respect to the moving distance of the read head crossing the track can be obtained easily by reading test data recorded in the track while moving the read head continuously in radial direction of the disk. With the profile of the read characteristics, the write sensitive width of the write head and the read sensitive width of the read head can easily be measured as the characteristic parameter of the composite magnetic head in the magnetic head test and, therefore, the composite magnetic head can be evaluated or tested.

FIG. 6 explains a prior art measuring method for measuring a write sensitive width of a write head and a read sensitive width of a read head as characteristic parameters of a magnetic head.

In FIG. 6, it is assumed that a write of test data in a designated track with write sensitive width Wa by a composite magnetic head (write head) has been completed already. In a read step of the test data, the test data is read by moving the composite magnetic head (read head) rightward in the drawing along a radial direction of the disk across the designated track.

In a position (1) shown in FIG. 6, a right side end of a read sensitive width Wb of an MR head (read head) corresponds to a left side end of the write sensitive width Wa of the test data. At this time, a gap (center line Cb) of the MR head can read the test data (the left side end thereof) written by the write head. In this case, the read voltage is still 0 (zero).

In order to simplify the description, the unit of the read voltage of the MR head is not [mV] but a ratio in a range between numerical value “0” and numerical value “1” under a maximum read voltage of the test data being 1. Incidentally, each of the sensitive widths Wa and Wb of the heads is determined by the gap width of the heads. The write sensitive width Wa of the write head (thin film inductive head) was usually in the order of several μm. In the DTM, the write sensitive width of the write head is in the order of 50 nm to 80 nm and the track width is 50 nm or less. Further, when the DTM rotates, the formed track is eccentric. Therefore, even if the write sensitive width of the write head is close to the track width substantially, there is a problem that the track width becomes narrower than the write sensitive width of the write head in the data recording state.

At a position (2), the read sensitive width Wb of the MR head enters into the side of the write sensitive width Wa by Wb/2. Therefore, Wb/2 of the right side of the read sensitive width Wb becomes on the write sensitive width Wa. In this state, the read voltage becomes 0.5 when the test data is written uniformly. When the MR head is moved rightward further to a position (3), the read sensitive width Wb overlaps the write sensitive width Wa completely. Therefore, the maximum read voltage becomes 1.0. When Wa>Wb, the voltage in the width range (Wa-Wb) becomes 1.0 evenly and the read voltage becomes flat. Therefore, when the MR head is at a position (4), the read voltage is 1.0. As a result, it is possible to obtain the profile (waveform) of the read voltage characteristics having a center flat portion as shown by a thick solid line. Incidentally, the head parameter measuring method of this kind is described in JP-2000-231707A and known publicly.

When the track width becomes narrower than the write sensitive width Wa of the write head as in the DTM, the read head can not cross the whole write region determined by the write sensitive width even if the read head is moved in radial direction. Therefore, there is the problem that the profile of the read voltage characteristics shown in FIG. 6 can not be obtained. Further, since the read sensitivity width of the read head in the DTM becomes close the track width, it is impossible to obtain the profile having the center flat portion as shown in FIG. 6. Therefore, it becomes difficult to measure the write sensitive width of the write head and the read sensitive width of the read head.

### SUMMARY OF THE INVENTION

An object of this invention is to provide a measuring method for easily measuring a write sensitive width of a write head and/or a read sensitive width of a read head by reading and writing data with respect to a DTM, etc., having a track width narrower than a write sensitive width of a write head.

Another object of this invention is to provide a measuring device for easily measuring a write sensitive width of a write head and/or a read sensitive width of a read head by reading and writing data with respect to a DTM, etc., having a track width narrower than the write sensitive width of the write head of a composite magnetic head.

In order to achieve these objects, the measuring method for measuring a write width and/or a read width of a composite magnetic head, comprises the steps of

positioning the composite magnetic head in a designated track of a magnetic recording medium such as a DTM which has eccentricity, a BPM which has eccentricity or other magnetic recording medium which has eccentricity and unevenly patterned recording layer and in which 2 tracks or more are accessed by the composite magnetic head in one revolution and writing a test data for one revolution in 2 tracks or more corresponding to the eccentricity by a write head,

shifting a position of said composite magnetic head in the designated track to a front or rear of said designated track, moving the position of the composite magnetic head in radial direction of the magnetic recording medium until it crosses the designated track and reading the test data written over the 2 tracks or more corresponding positions in the radial direction, and

obtaining a profile of a read characteristics having a peak of a read voltage corresponding to the moving distance in the radial direction of the composite magnetic head on the basis of a read signal of the read head and calculating the write sensitive width or the read sensitivity width.

In this invention, the read characteristics profile having a peak of read voltage characteristics with respect to a moving distance is obtained and the write sensitive width or the read sensitive width is calculated on the read characteristics profile, by writing the test data in the designated track of DTM, etc., having eccentric tracks by the composite magnetic head (write head) and reading the test data from the designated track by moving a position of the composite magnetic head in the designated track in radial direction of the disk across the designated track.

The write sensitive width Wa is the head moving distance in the radial direction at the read voltage which is 50% of the peak read voltage in this read characteristics profile.

On the other hand, the read sensitive width can be obtained on the basis of a profile approximate to the read characteristics having a center flat portion of the read characteristics profile by obtaining approximate linear lines on the both sides from the curved lines of the both sides in the read characteristics profile. Further, it is possible to obtain the write sensitive width of the write head from this profile similarly.

As a result, even for the DTM or BTM in which the track width is narrower than the write sensitive width of the write head, the write sensitive width of the write head and the read sensitive width of the read head can be measured similarly to the prior art magnetic disk.

### BRIEF DESCRIPTION OF THE DRAWINGS

FIG. 1 is a block diagram of an MR composite magnetic head write/read width measuring device according to an embodiment of this invention to which the method for measuring the write width/read width of the composite magnetic head is applied.

FIG. 2 is a flow chart of a read characteristic measuring process of a test magnetic head.

FIG. 3(a) shows a write locus when test data is written in an eccentric track of a discrete track medium (DTM) and FIG. 3(b) shows a read locus when the test data is read out from the eccentric track of the discrete track medium (DTM).

FIG. 4 shows a measured read characteristics profile and a profile approximating a read characteristics profile corresponding to a conventional magnetic head.

FIG. 5 shows partial tracks of a discrete track medium (DTM) to which the magnetic head to be tested accesses.

FIG. 6 explains a conventional measuring method in which a write sensitive width of a write head and a read sensitive width of an MR head are measured as a characteristic parameter of a magnetic head.

### DESCRIPTION OF THE PREFERRED EMBODIMENT

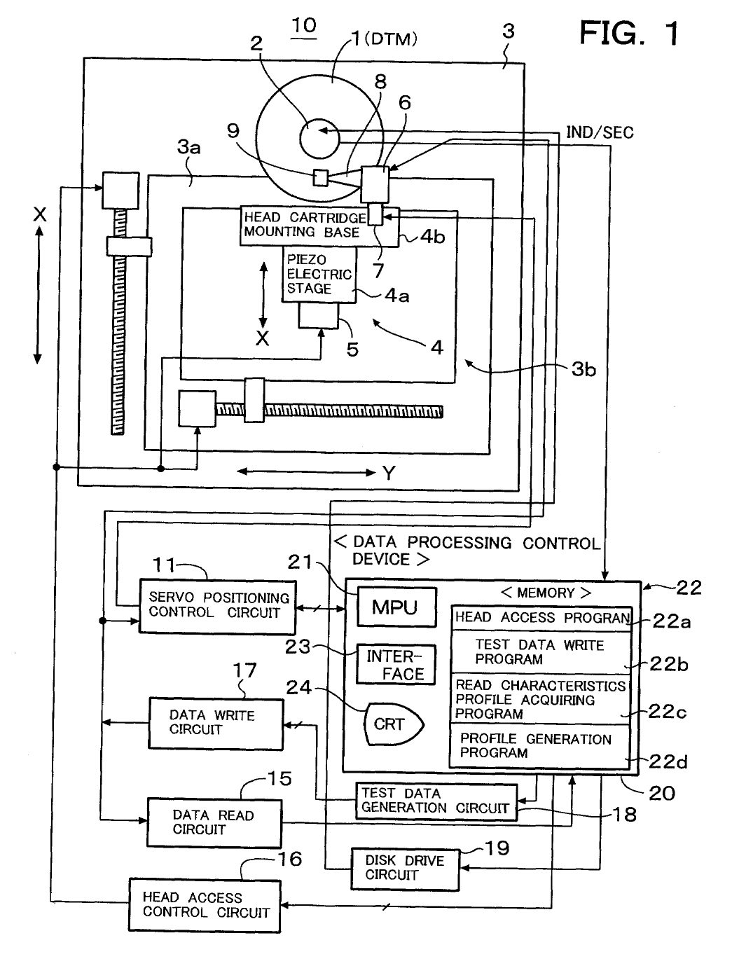

In FIG. 1, a reference numeral 10 depicts a magnetic head tester and a reference numeral 1 depicts a DTM (discrete track medium) which is mounted on a spindle 2 detachably. An XY stage 3 as a head carriage is provided adjacent to the spindle 2. The XY stage 3 is composed of an X stage 3a and a Y stage 3b.

Incidentally, the DTM 1 is a disk whose discrete tracks are eccentric with respect to a rotation center of the spindle 2 when it is mounted on the spindle 2. In a usual DTM, a center of the DTM is eccentric with respect to a rotation center of a spindle 2 and a center of discrete tracks formed in the DTM are eccentric with respect to the center of the DTM. Therefore, the tracks formed in the disk become eccentric with respect to the rotation center of the spindle unless the eccentricity is corrected stepwise. For this reason, it can be said that 2 tracks or more become eccentric in the DTM 1 mounted on the spindle 2.

The X stage 3a is movable in a radial direction of the DTM 1 so that a piezoelectric stage 4 on which a composite magnetic head 9 which has the MR head (read head) and the thin film inductive head (write head) and is an object to be tested is mounted is movable in the radial direction of the DTM 1 through the Y stage 3b.

The Y stage 3b is mounted on the X stage 3a for moving the head 9 for a skew regulation with respect to the head 9. The piezoelectric stage 4 for finely regulating a position of the head 9 in X direction is mounted on the Y stage 3b.

The piezoelectric stage 4 is composed of a movable base 4a, a head cartridge mounting base 4b and a piezoelectric actuator 5. The head cartridge mounting base 4b is connected to a top side of the movable base 4a. The movable base 4a is mounted on the Y stage 3b through the piezoelectric actuator 5 to move the head cartridge mounting base 4b along X axis.

Thus, when the piezoelectric actuator 5 is driven, the head cartridge mounting base 4b moves in X direction and the fine regulation of the head position in the radial direction of the DTM 1 is performed through a head cartridge 6. Incidentally, the X direction is coincident to a radial direction passing through the center of the DTM 1.

The head cartridge 6 is mounted on the head cartridge mounting base 4b through the piezoelectric actuator 7 and a suspension spring 8 is fixed onto the head cartridge 6. The piezoelectric actuator 7 may be mounted inside of the head cartridge 6. In such case, the piezoelectric actuator is mounted between the suspension spring 8 and a head mounting base of the suspension spring 8 of the head cartridge 6 in such a way that the head 9 can be moved radially through the suspension spring 8. Since, in this case, the mass to be driven by the piezoelectric actuator 7 becomes small, it is possible to improve the responsibility of the ON truck servo control.

The head 9 is mounted on a top end side of the suspension spring 8. The head 9 performs the so-called head access operation for reading data from one of the tracks of the DTM 1 or writing data in the track by moving the head 9 radially along the X axis direction of the DTM 1 to scan the tracks of the DTM 1 and positioning the head 9 in the track.

The head cartridge 6 mounts the head 9 on a head carriage detachably and includes a read amplifier and a write amplifier therein. The read amplifier receives a read signal from the MR head, amplifies the read signal and outputting the amplified signal to a data read circuit 15 and a servo positioning control circuit 11.

The servo positioning control circuit 11 is composed of an aimed position voltage generator circuit, a servo voltage demodulation•position voltage arithmetic circuit, an error voltage generator circuit, a phase compensation filtering circuit for the piezoelectric actuator 7 on the cartridge side and a piezoelectric actuator driver, etc., and reads servo information provided correspondingly to sectors to perform the servo control (ON track servo control) in such a way that the head 9 becomes ON track state with respect to the aimed track positioned correspondingly to the servo information.

Incidentally, the servo information is usually composed of a 4-phase burst signal having A phase, B phase, C phase and D phase which are sequentially separated by W/4 each other in the radial direction of a track having width of W.

A data read circuit 15 receives a read signal of the MR head from a read amplifier provided in the head cartridge 6, binarizes the read signal and sends the designated signal to a data processing•control device 20. A reference numeral 16 depicts a head access control circuit. The head access control circuit 16 receives a control signal from the data processing•control device 20 to drive the XY stage 3 and the piezoelectric actuator 5 to thereby position the head 9 in a designated track.

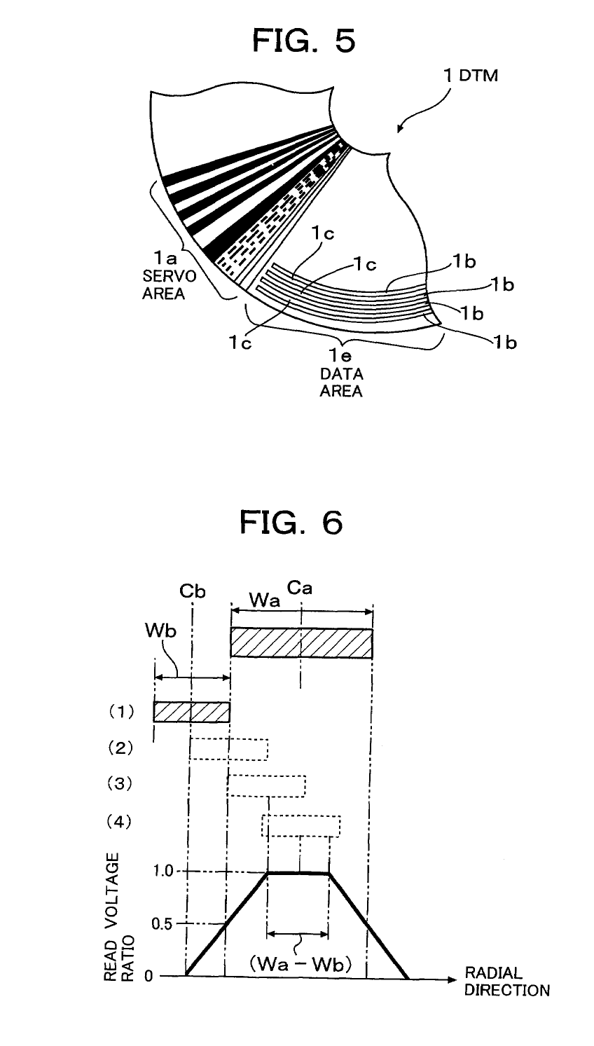

A reference numeral 17 depicts a data write circuit and a reference numeral 18 depicts a test data generation circuit. The test data generation circuit 18 generates a designated test data under control of the data processing•control device 20 and sends the test data to the data write circuit 17. The data write circuit 17 generates a write signal according to the test data, drives a write amplifier provided in the head cartridge 6 and writes the data in a designated track through the thin film inductive head of the head 9. FIG. 5 shows about one forth section of the DTM 1 to explain the portion of the DTM, which is accessed by a magnetic head to be tested.

Servo areas 1a corresponding to respective sectors are provided in the DTM 1. In the servo area 1a, track position information, servo information (servo burst signal) for determining ON track position and a sector number, etc., are recorded. Following the servo areas, discrete tracks 1b are formed, respectively, and an area between the adjacent discrete tracks 1b is filled with a non-magnetic member 1c.

The discrete tracks 1b constitute a data area 1e in which the test data, etc., is written. The width of the discrete truck 1b is in the order of 50 nm to 60 nm. The write sensitive width Wa of the head 9 is 60 nm or more at present.

Returning to FIG. 1, the data processing•control device 20 is constructed with an MPU 21, a memory 22, an interface 23, a CRT display 24 and a key board, etc., and these components are mutually connected by a bus. In the memory 22, a head access program 22a, a test data write program 22b, a read characteristics profile acquiring program 22c and a profile generation program 22d for generating a profile approximating the read characteristics, etc., are stored.

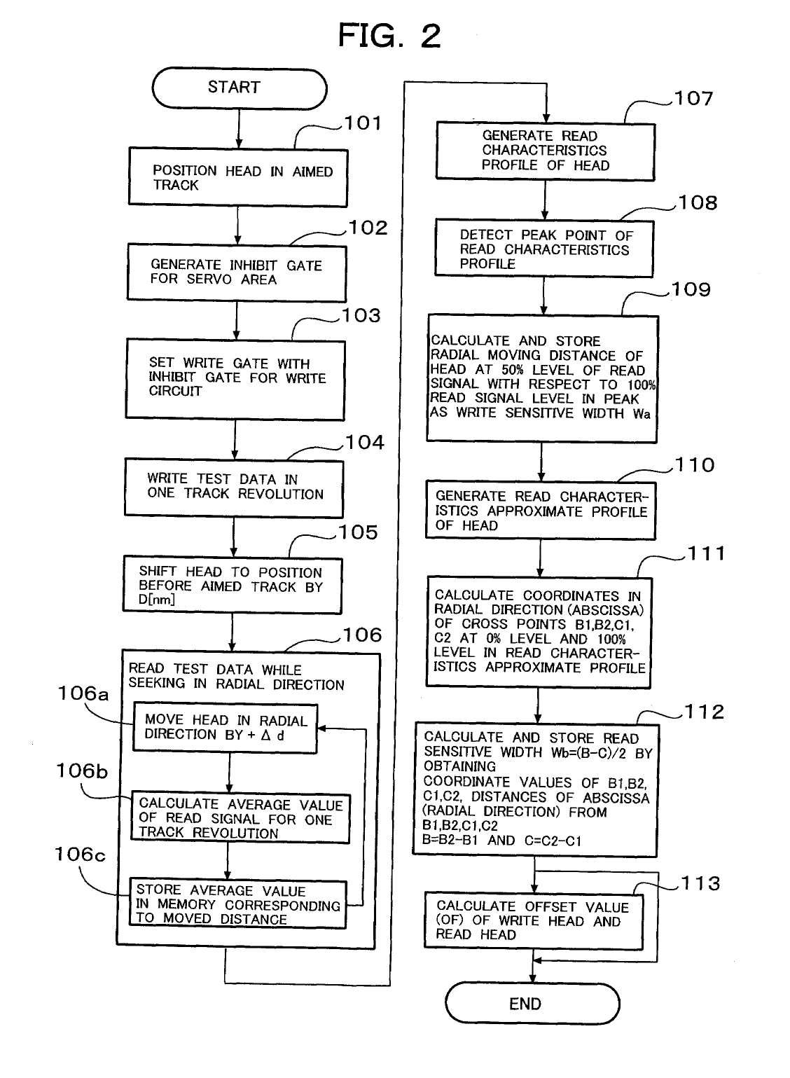

FIG. 2 shows a flow chart of the read characteristics measuring process of the test magnetic head.

The MPU 21 activates the head access control circuit 16 by setting a moving distance r [mm] in R direction in a designated register of the head access control circuit 16 through the interface 23 by executing the head access program 22a.

By setting the moving distance r [mm] in the R direction in the register, the X stage 3a is driven by the head access control circuit 16 to roughly move the head from a reference point or a designated track position by r [mm] and then the piezoelectric stage 4 is driven to finely move the head 9 by the distance r, so that the head 9 is positioned in an aimed track (Step 101). Therefore, the head 9 is positioned at the center of the aimed track from the reference point or the designated truck position.

Then, the MPU 21 calls the test data write program 22b and executes the program to generate an inhibit gate for the servo area 1a (Step 102) and set a write gate with the inhibit gate for the write amplifier provided in the head cartridge 6 through the data write circuit 17 (Step 103). Then, the test data is generated and the test data for one truck is written in the aimed track (Step 104).

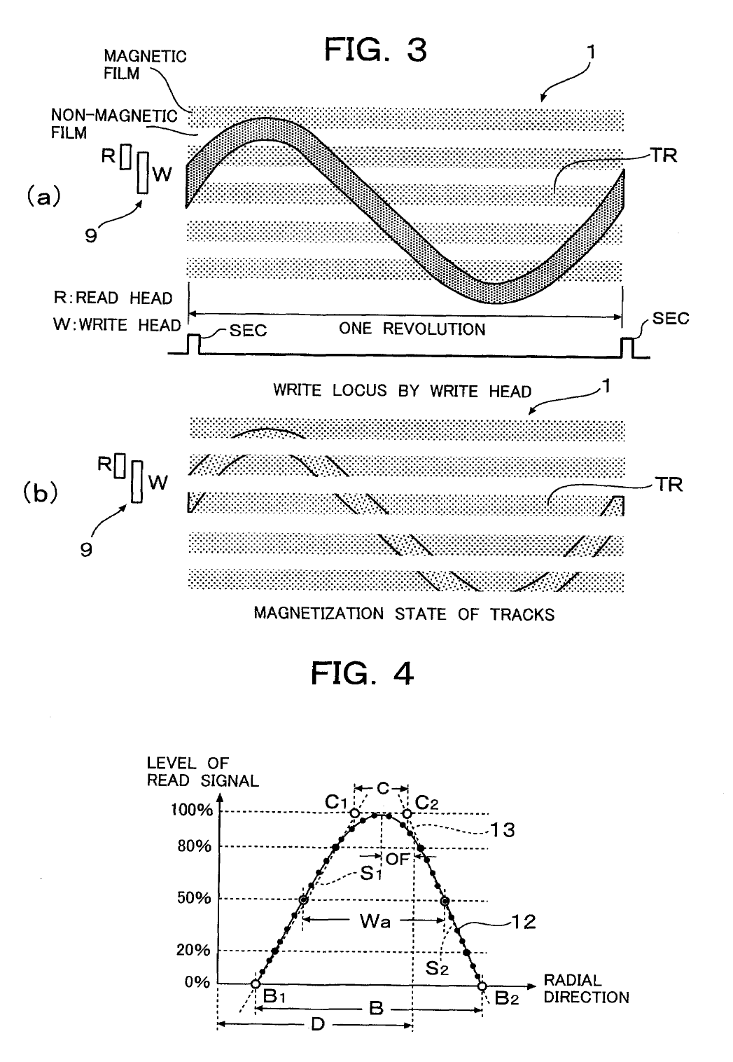

At the time of writing of the test data after the head 9 is positioned in the aimed track, the write head waits for a sector signal SEC shown in FIG. 3(a) regardless of an index signal IND which is a start point signal of one track revolution or a start sector signal of one revolution, and enters into the writing of the test data for one truck corresponding to the sector signal SEC. As a result, test data is written in an eccentric track of the DTM 1 including the aimed track as shown in FIG. 3(a). Sector signals obtained by dividing one track revolution of a disk by a predetermined number, are generated in synchronism with the index signal INDX by a rotary encoder of the spindle 2 shown in FIG. 1. These sector signals may be generated in the data processing•control device 20 by dividing one track revolution in response to the index signal INDX by a software processing.

Incidentally, in the data reading time, the read gate with inhibit gate is set in the read amplifier provided in the head cartridge 6 by the generation of this inhibit gate. Since, therefore, the servo area 1a is masked by the inhibit gate and the reading is not performed, a read signal of this portion is not generated. In a case of the DTM 1 in which the servo area 1a is not formed, the generation of the inhibit gate in the step 102 is unnecessary.

FIG. 3(a) shows the recording state of the DTM 1 in the step 104. TR shown in FIG. 3(a) is the aimed track. As shown in FIG. 3(a), the test data written in the track TR is recorded as a locus approximating a sine waveform over trucks before and after the track TR due to the eccentricity of the tracks on the DTM 1.

In FIG. 3(a), the eccentricity of a track on the DTM 1 covers 5 tracks including 2 tracks forward the track and 2 tracks backward of the track. Since, in this case, the track is discrete tracks, the magnetization state of the track on the DTM 1 becomes not the continuous track locus as shown in FIG. 3(b) but a serpentine track locus over a plurality of tracks.

After the writing of the test data in such recording state is ended (after the execution of the test data write program 22b), the MPU 21 calls the read characteristics profile acquiring program 22c to read the test data written in the 2 tracks or more by the read head (MR head) while moving the read head in the radial direction of the DTM 1.

That is, the MPU 21 executes the read characteristics profile acquiring program 22c to call and execute the head access program 22a. In this case, the head access control circuit 16 is activated by setting the moving distance −D [nm] in the R direction in a designated register of the head access control circuit 16 through the interface 23.

By setting the moving distance −D[nm] in the R direction in the register to move a position of the head 9 in the aimed track TR to a front or rear of the aimed track TR, the piezoelectric actuator 5 is driven by the head access control circuit 16 to shift the head 9 to a position D[nm] immediately before the aimed track TR from the center of the aimed track TR (Step 105).

Next, in the position shifted from the center of the aimed track TR by −D [nm] immediately before the aimed track TR, the MR head (read head) waits for an index signal IND which is a start point signal of one track revolution (or a start sector signal of one revolution) and enters into the reading of test data.

In a first reading of a track of one revolution, the MPU 21 skips Step 106a to be described next, enters into Step 106b and then is shifted to Step 106a through Step 106c. Thereafter, the head 9 is moved in the radial direction by +Δd [nm] (where Δd<<D) (Step 106a) to read the track for one revolution, calculates an average value of the read signal voltage for one revolution (Step 106b) and stores the average value for one revolution in a designated area of the memory 22 correspondingly to the head moving distance in the radial direction (Step 106c), repeatedly.

By Step 106a-106c, the MPU 21 moves the position of the head 9 in radial direction of the DTM 1 until it crosses the aimed track TR.

Thus, the MPU 21 repeats the reading of the test signal for one revolution from the position immediately before the aimed track TR to the position after the aimed track TR while seeking the head 9 in the radial direction to execute the read operation covering all of the locus of the recording test data as shown in FIG. 3(b) (Step 106).

In this case, when the head 9 is moved in the radial direction of the DTM 1 by −D [nm], the head 9 (MR head) traces the locus, which is the same as the track locus when the test data is written and is shifted by −D [nm]. Therefore, by Step 106, the head can cross a serpentine track locus, which is formed by the eccentricity of the tracks shown in FIG. 3(b) at the time of write of the test data, in the radial direction.

As shown in FIG. 3(a), the eccentricity of the DTM 1 is in the order of 5 tracks in the locus of the test data. However, when the MR head is moved along the serpentine track locus during the write of the test data in the radial direction every track revolution and the read of the recorded test data is performed from a position immediately before the aimed track TR to a position immediately after the aimed track TR, the write sensitive widths in the reading locus in the aimed track TR are sequentially traced by the MR head regardless of the eccentricity, similarly to the conventional acquisition of the read characteristics profile, though the recording test data is spread and sectioned over a plurality of tracks. Further, the range of the write sensitive width of the write head is completely covered by the read head, theoretically.

As a result, the MPU 21 can acquire the read characteristics profile 12, which has a peak read voltage for the moving distance of the head 9 in the radial direction as shown in FIG. 4. Incidentally, black pointed positions are the measuring points. The abscissa shows the moving distance of the head 9 in the radial direction and the ordinate shows a ratio of the read voltage with respect to the maximum read voltage value of 1.0.

Therefore, the MPU 21 generates the read characteristics profile 12 (shown by a solid line) having the read voltage peak of the moving distance of the head 9 (the MR head) by executing the read characteristics profile program 22c on the basis of the average value obtained for the moving distance of the head 9, which is recorded in the step 106c and interpolating the measuring points of the moving distance in the radial direction (Step 107).

Then, the MPU 21 detects a level of the read signal at the peak point of the read characteristics profile 121 (Step 108).

Then, the MPU 21 converts the read voltage of the measured value to a ratio with respect to the peak value (maximum voltage value) which is 1.0. The level of the read signal at the peak point is set as 100% and the moving distance (abscissa) of the head 9 (write head) in the radial direction corresponding to the 50% read signal level is calculated as the write sensitive width Wa and stores it in a designated area of the memory 22 (Step 109).

The thus obtained read characteristics profile shown in FIG. 4 has the flat portion in the center portion unlike the conventional waveform shown in FIG. 6. However, since there is the relation [sensitivity width of MR head]<[write sensitive width of the write head] in the present invention and the practical sensitive width of the MR head (read head) is smaller than the track width (width of the track locus in the radial direction) in the recorded locus, there may be some read area (flat portion) in the radial direction in which the sensitive width of the MR head is in the write sensitive width during the movement of the head in the track width direction.

It is considered that the characteristics including a peak and substantially no flat portion such as shown by the read characteristics profile 12 is caused by that the track width and the width of the MR head are similar and that the MR head can not read an enough test data because the read of the MR head is performed with respect to the sectioned magnetization state.

Therefore, a profile 13, which approximates to the conventional read characteristics having a flat portion in the center top portion, is obtained from the curved lines on both sides in the read characteristics profile 12 shown in FIG. 4 (Step 110).

That is, the MPU 21 calls and executes a profile generation program 22d for generating a profile, which approximates to the read characteristics, after the execution of the read characteristics profile acquiring program 22c is ended. The MPU 21 generates the profile 13 by obtaining tangential lines S1 and S2 corresponding to the curved lines between slice levels assigned to the both side curved lines, for example, the curved lines between the slice levels 20% and 80% and replacing the both side curved lines of the read characteristics profile 12 by the tangential lines S1 and S2.

The MPU 21 calculates the read sensitive width Wb of the MR head from Wb=(B−C)/2 by setting points B1 and B2 at which the tangential lines S1 and S2 intersect the 0% level line (abscissa) and points C1 and C2 at which the tangential lines S1 and S2 intersect the 100% level line and obtaining these points from the coordinates of the radial direction (Step 111) as a moving distance B of the head 9 in the radial direction between the points B1 and B2 and as a moving distance C of the head 9 in the radial direction between the points C1 and C2 (Step 112).

The distance (B−C) in the approximate profile 13 of the read characteristics is a sum of inclined portions in the opposite end portions of this waveform in the radial direction. In FIG. 6, an inclined portion on the left side in FIG. 6 is a moving distance of the MR head in the radial direction from a time when the MR head inters into the write area of the test data to a time when it enters into the write area completely. This distance corresponds to the read width Wb of the MR head. The inclined portion on the right side in FIG. 6 is a moving distance of the MR head in the radial direction from a time when the MR head exits from the write area of the test data to a time when it exits from the write area completely. This distance corresponds to the read width Wb of the MR head too.

The read relation of the curved lines on the both sides of the test data obtained by the read head is the same as the relation when the conventional read voltage profile shown in FIG. 6. Therefore, the approximate profile 13 of the read characteristics, which is obtained by replacing the curved lines on the both sides with the tangential lines S1 and S2, has the characteristics close to the conventional read characteristics.

Since such the inclined portions exist in the front and rear sides, the average value is obtained by (B−C)/2 as the read sensitive width Wb.

Incidentally, in the read characteristics profile 13 shown in FIG. 4, the abscissa is the moving distance of the head 9 in the radial direction. In Step 105, the movement of the head 9 is started at the position D[nm] before the aimed track TR. Therefore, the position of the distance D[nm] from the original point of the abscissa in FIG. 4 becomes the position at which the head 9 head is positioned by the aimed track TR position and the test data is written by the write head. This position also corresponds to the position at which the head 9 is positioned in the aimed track TR and the read head reads the test data. Therefore, a distance OF in the radial direction from this position to a position at which the read head reads the peak voltage is the distance of the gap between the write head and the read head, that is, the offset amount of the write head and the read head.

Therefore, it is possible to provide Step 113 for calculating the offset amount in the data of the read characteristics approximating profile 12 or 13 shown in FIG. 4, next to Step 112. Incidentally, the position of the peak point in the read characteristics approximating profile 13 is the center value of the flat portion.

In the case mentioned above, the tangential lines S1 and S2 with respect to the curved lines on the both sides of the read characteristics approximating profile 13 are to obtain linear lines approximating to the curved lines on the both sides. Therefore, in lieu of the acquisition of the tangential lines, it is possible obtain the approximate linear lines on the both sides by approximating the curved lines between 20% and 80% or by applying the least squares method to the measuring values in this range.

Further, the calculation of the write sensitive width Wa in Step 112 may be performed together with the calculation of the read sensitive width Wb in not the read characteristics profile 12 but the read characteristics approximate profile 13.

Further, the slice levels of 20% and 80% for determining the range of the curved lines on the both sides of the read characteristics approximate profile 13 are a mere example. In this invention, it is enough to obtain the approximate linear lines in the range of the curved lines including the measuring values near 50% and the range is not limited to from 20% to 80%. The reason for inclusion of the curved lines of the measuring value of around 50% is that, since a half of the MR head enters in the write area of the test data in this range, the test data is read without substantial influence of the around recording state. Further, in this state, the relation between the MR head and the recorded information is close to the relation when the conventional read characteristics of the magnetic head is obtained though the recording state of the test data is fragmentary.

In the described embodiment, when the test data is read, the read head is moved from the front of the aimed track in the radial direction and crosses the track, in which the test data is written, till the rear side. However, in this case, it is of course possible to move the read head from the rear of the aimed track in the radial direction and to crosses the track, in which the test data is written, till the front side.

Further, the eccentricity of the DMT 1 in this embodiment is a mere example. When the DMT 1 is mounted on a spindle with eccentricity with which 2 or more tracks are accessed in one revolution, it is possible to measure the write sensitive width of the write head and the read sensitive width of the read head. The reason for this is that, since the write sensitive width is within a range of 1 track or a range which does not cover 2 tracks, it is possible to obtain the track locus corresponding to the write sensitive width by accessing the 2 tracks or more in even fragmented DTM or BPM.

The DTM in this embodiment is a mere example and this invention can use a BPM (bit patterned medium) or other magnetic recording medium having an unevenly patterned recording layer.

1. A measuring method for measuring a write width and/or a read width of a composite magnetic head by writing a test data in a designated track by said composite magnetic head having a write head and a read head, obtaining a read characteristics of said composite magnetic head by moving said composite magnetic head in a radial direction of a disk and reading a test data corresponding to positions in the radial direction, comprising the steps of:
positioning the composite magnetic head in a designated track of a magnetic recording medium such as a magnetic recoding medium of a discrete track type which has eccentricity, a magnetic recoding medium of a bit patterned type which has eccentricity, or other magnetic recording medium which has eccentricity and unevenly patterned recording layer, with which 2 tracks or more are accessed in one revolution of said designated track by said composite magnetic head mounted on a spindle, and writing the test data over 2 tracks or more for one revolution corresponding to the eccentricity by said write head,
shifting a position of said composite magnetic head in the designated track to a front or rear of said designated track, moving the position of said composite magnetic head in the radial direction of said magnetic recording medium until it crosses said designated track and reading the test data written over the 2 tracks or more correspondingly to the positions in the radial direction by said read head, and
calculating a write sensitive width or a read sensitive width by obtaining a read characteristics profile having a read voltage peak for a moving distance of said composite magnetic head in the radial direction on the basis of a read signal of said read head.

2. A measuring method for measuring a write width and/or a read width of a composite magnetic head as claimed in claim 1, wherein the write head waits for a sector signal and enters into the writing of the test data.

3. A measuring method for measuring a write width and/or a read width of a composite magnetic head as claimed in claim 2, wherein approximate linear lines of both sides of the peak of the read characteristics profile are obtained from curved portions of the both sides of the peak and a read characteristics approximate profile having a flat portion in an upper portion of the read characteristics profile on the basis of the approximate linear lines of the both sides, the read sensitive width is calculated on the basis of the read characteristics approximate profile.

4. A measuring method for measuring a write width and/or a read width of a composite magnetic head as claimed in claim 3, wherein the write sensitive width is calculated on the basis of the read characteristics approximate profile.

5. A measuring method for measuring a write width and/or a read width of a composite magnetic head as claimed in claim 4, wherein said magnetic recording medium is of the discrete track type and a track width is equal to or narrower than the write sensitive width of the write head.

6. A measuring method for measuring a write width and/or a read width of a composite magnetic head as claimed in claim 5, wherein said read head and said write head of said composite magnetic head are an MR head and a thin film inductive head, respectively, the approximate linear lines are calculated by calculation of tangential lines, a linear approximation or approximation by minimum square method for curved portions of the both sides of the read characteristics profile including read level of 50% of the maximum read level.

7. A measuring method for measuring a write width and/or a read width of a composite magnetic head as claimed in claim 6, wherein a read voltage of the read characteristics profile is an average value of the read signal voltage for one revolution and the approximate linear lines are calculated on the basis of the curves portions of the both sides in a read level range from 20% to 80% of the maximum read level.

8. A measuring method for measuring a write width and/or a read width of a composite magnetic head as claimed in claim 3, wherein the read sensitive width of said MR head is calculated by (B−C)/2, where B is a moving distance of the composite magnetic head in a radial direction between a point B1 and a point B2 which are intersection points of the approximate linear line on the both sides and a line of read level of 0% of the read characteristics profile and C is a moving distance of said composite magnetic head in a radial direction between a point C1 and a point C2 which are intersection points of the approximate linear line on the both sides and a line of read level of 100% of said read characteristics profile.

9. A measuring method for measuring a write width and/or a read width of a composite magnetic head as claimed in claim 1, wherein a distance from a position of the read characteristics profile corresponding to the position of said composite magnetic head when it is positioned in the designated track to the peak position in the radial direction is further calculated as an offset amount of said read head and said write head.

10. A measuring method for measuring a write width and/or a read width of a composite magnetic head as claimed in claim 3, wherein a distance from a position of the read characteristics profile corresponding to the position of said composite magnetic head when it is positioned in the designated track to the peak position in the radial direction is further calculated as an offset amount of said read head and said write head.

11. A write/read width measuring device using a measuring method for measuring a write width and/or a read width of a composite magnetic head as claimed in claim 1.

12. A write/read width measuring device using a measuring method for measuring a write width and/or a read width of a composite magnetic head as claimed in claim 2.

13. A write/read width measuring device using a measuring method for measuring a write width and/or a read width of a composite magnetic head as claimed in claim 3.
